(19) United States
(12) Patent Application Publication
(10) Pub. No.: US 2025/0209394 A1
(43) Pub. Date: Jun. 26, 2025

(54) HEURISTIC-BASED APPROACH TO MULTI-OBJECTIVE SCHEDULE OPTIMIZATION IN CONTACT CENTERS

(71) Applicant: Genesys Cloud Services, Inc., Menlo Park, CA (US)

(72) Inventors: Bill D’Attilio, Menlo Park, CA (US); German Velasquez Diaz, Menlo Park, CA (US); Temitayo Bankole, Menlo Park, CA (US); Wei Xun Ter, Menlo Park, CA (US); Bayu Wicaksono, Menlo Park, CA (US); Paul Wood, Menlo Park, CA (US)

(21) Appl. No.: 18/395,468

(22) Filed: Dec. 22, 2023

(51) Int. Cl. G06Q 10/0631; H04M 3/51

(52) U.S. Cl. CPC G06Q 10/063118; H04M 3/51

(57) ABSTRACT

A method of leveraging a heuristic-based approach to multi-objective schedule optimization in contact centers according to an embodiment includes adding, by a computing system, assignable contact center agents to pre-existing scheduled sessions, selecting, by the computing system, a session from a plurality of candidate sessions to open in response to adding the assignable contact center agents to the pre-existing scheduled sessions, opening, by the computing system, the selected session, and assigning, by the computing system, unassigned contact center agents to the opened session, wherein at most one session of the plurality of candidate sessions is open for assignment at a given time.

### BACKGROUND

Contact centers rely on agents to communicate with and respond to client inquiries. Contact center performance is generally measured in terms of two conflicting objectives: quality of service and cost. Quality may be measured in terms of service level, average handle time, and abandonment rate. Although contact center costs may come from different sources, the most important costs in a contact center are typically associated with staffing. Therefore, contact centers attempt to schedule the right number of employees with the right skills at the right time to handle the interaction workload and meet the relevant quality standards. Traditional scheduling technologies are insufficient to handle the complexities and scale of modern contact centers.

### SUMMARY

Various embodiments are directed to one or more unique systems, components, and methods for multi-objective schedule optimization in contact centers. Other embodiments are directed to apparatuses, systems, devices, hardware, methods, and combinations thereof for multi-objective schedule optimization in contact centers.

According to an embodiment, a method for multi-objective schedule optimization in contact centers utilizing a mixed integer programming model may include determining, by a computing system, the mixed integer programming model based on a plurality of constraints and a plurality of optimization objectives, receiving, by the computing system, an activity rule from a rule queue of activity rules to be scheduled, and scheduling, by the computing system, a plurality of contact center agents to one or more activity sessions based on the activity rule by finding an optimal solution to a mixed integer programming problem generated based on the mixed integer programming model and the activity rule.

In some embodiments, the method may further include receiving, by the computing system, schedule information for the contact center, finding, by the computing system, possible candidate sessions based on the schedule information, estimating, by the computing system, contributions of each of the plurality of contact center agents and facilitators to each of a plurality of planning groups of the contact center, identifying, by the computing system, concurrent sessions based on the possible candidate sessions, identifying, by the computing system, incompatible sessions based on the possible candidate sessions, and determining, by the computing system, overstaffing with respect to minimum staffing requirements for each of the plurality of planning groups of the contact center.

In some embodiments, the plurality of optimization objectives may include an optimization objective to minimize unassigned contact center agents.

In some embodiments, the plurality of optimization objectives may include an optimization objective to minimize understaffing caused by scheduling the one or more activity sessions.

In some embodiments, the plurality of optimization objectives may include an optimization objective to minimize interrupted activity sessions.

In some embodiments, the plurality of optimization objectives may include an objective to minimize a percentage of opened sessions.

In some embodiments, the plurality of constraints may include a constraint that agents must be either unassigned or assigned to one session.

In some embodiments, the plurality of constraints may include at least one constraint that a number of contact center agents assigned to a scheduled session must be at least a minimum group size and no greater than a maximum group size.

In some embodiments, the plurality of constraints may include a constraint that previously scheduled sessions cannot be unscheduled.

In some embodiments, the plurality of constraints may include a constraint that a number of total sessions scheduled is no greater than a maximum total session count.

In some embodiments, the plurality of constraints may include a constraint that a number of concurrent sessions must be no greater than a maximum number of concurrent sessions.

In some embodiments, the plurality of constraints may include a constraint that only one of two incompatible sessions can be scheduled.

In some embodiments, the plurality of constraints may include a constraint that defines whether understaffing below minimum staffing requirements for respective planning groups is permitted.

In some embodiments, the method may further include updating, by the computing system, the activity rule in response to scheduling the activity rule based on one or more recurrence settings of the activity rule, and adding, by the computing system, the updated activity rule to the rule queue.

In some embodiments, the method may further include adding, by the computing system, an initial set of activity rules to the rule queue, and wherein receiving the activity rule from the rule queue may occur subsequently to adding the initial set of activity rules to the rule queue.

According to another embodiment, a computing system for multi-objective schedule optimization in contact centers utilizing a mixed integer programming model may include at least one processor and at least one memory comprising a plurality of instructions stored thereon that, in response to execution by the at least one processor, causes the computing system to determine the mixed integer programming model based on a plurality of constraints and a plurality of optimization objectives, receive an activity rule from a rule queue of activity rules to be scheduled, and schedule a plurality of contact center agents to one or more activity sessions based on the activity rule by finding an optimal solution to a mixed integer programming problem generated based on the mixed integer programming model and the activity rule.

In some embodiments, the plurality of instructions may further cause the computing system to receive schedule information for the contact center, find possible candidate sessions based on the schedule information, estimate contributions of each of the plurality of contact center agents and facilitators to each of a plurality of planning groups of the contact center, identify concurrent sessions based on the possible candidate sessions, identify incompatible sessions based on the possible candidate sessions, and determine overstaffing with respect to minimum staffing requirements for each of the plurality of planning groups of the contact center.

In some embodiments, the plurality of optimization objectives may include a first optimization objective to minimize unassigned contact center agents, a second optimization objective to minimize understaffing caused by scheduling the one or more activity sessions, a third optimization objective to minimize interrupted activity sessions, and a fourth optimization objective to minimize a percentage of opened sessions.

In some embodiments, the plurality of constraints may include a first constraint that contact center agents must be either unassigned or assigned to one session, a second constraint that a number of contact center agents assigned to a scheduled session must be at least a minimum group size, a third constraint that the number of contact center agents assigned to the scheduled session must be no greater than a maximum group size, a fourth constraint that previously scheduled sessions cannot be unscheduled, a fifth constraint that a number of total sessions scheduled is no greater than a maximum total session count, a sixth constraint that a number of concurrent sessions must be no greater than a maximum number of concurrent sessions, a seventh constraint that only one of two incompatible sessions can be scheduled, and an eighth constraint that defines whether understaffing below minimum staffing requirements for respective planning groups is permitted.

In some embodiments, the plurality of instructions may further cause the computing system to update the activity rule in response to scheduling the activity rule based on one or more recurrence settings of the activity rule, and add the updated activity rule to the rule queue.

According to yet another embodiment, a method of leveraging a heuristic-based approach to multi-objective schedule optimization in contact centers may include adding, by a computing system, assignable contact center agents to pre-existing scheduled sessions, selecting, by the computing system, a session from a plurality of candidate sessions to open in response to adding the assignable contact center agents to the pre-existing scheduled sessions, opening, by the computing system, the selected session, and assigning, by the computing system, unassigned contact center agents to the opened session, wherein at most one session of the plurality of candidate sessions is open for assignment at a given time.

In some embodiments, adding the assignable contact center agents to pre-existing scheduled sessions may include sorting the assignable contact center agents in descending order by at least one of a respective average number of sessions since a last time the respective assignable contact center agent was scheduled, an on queue percentage of the respective assignable contact center agent, and a resulting quality of service of the contact center if the respective assignable contact center agent is assigned.

In some embodiments, adding the assignable contact center agents to the pre-existing scheduled sessions may further include assigning the assignable contact center agents according to the sorted descending order.

In some embodiments, selecting the session from the plurality of candidate sessions to open may include determining a respective percentage of contact center agents that can attend each session of the plurality of candidate sessions.

In some embodiments, selecting the session from the plurality of candidate sessions to open may include determining overstaffing with respect to minimum staffing requirements for each of a plurality of planning groups of the contact center that the unassigned contact center agents can handle.

In some embodiments, the method may further include re-assigning, by the computing system, at least one contact center agent assigned to another session in response to determining that a number of contact center agents assigned to the opened session is not at least a minimum group size for the opened session.

In some embodiments, assigning the unassigned contact center agents to the opened session may include sorting the unassigned contact center agents in descending order by a respective average number of sessions since a last time the respective unassigned contact center agent was scheduled.

In some embodiments, assigning the unassigned contact center agents to the opened session may include sorting the unassigned contact center agents in descending order by an on queue percentage of the respective unassigned contact center agent.

In some embodiments, assigning the unassigned contact center agents to the opened session may include sorting the unassigned contact center agents in descending order by a resulting quality of service of the contact center if the respective unassigned contact center agent is assigned.

In some embodiments, assigning the unassigned contact center agents to the opened session may include assigning the unassigned contact center agents to the opened session until an allowable negative impact to coverage of the contact center is met.

In some embodiments, assigning the unassigned contact center agents to the opened session may include assigning the unassigned contact center agents to the opened session until a maximum session size is met.

According to another embodiment, a computing system for leveraging a heuristic-based approach to multi-objective schedule optimization in contact centers may include at least one processor and at least one memory comprising a plurality of instructions stored thereon that, in response to execution by the at least one processor, causes the computing system to add assignable contact center agents to pre-existing scheduled sessions, select a session from a plurality of candidate sessions to open in response to adding the assignable contact center agents to the pre-existing scheduled sessions, open the selected session, and assign unassigned contact center agents to the opened session, wherein at most one session of the plurality of candidate sessions is open for assignment at a given time.

In some embodiments, to add the assignable contact center agents to pre-existing scheduled sessions may include to sort the assignable contact center agents in descending order by at least one of a respective average number of sessions since a last time the respective assignable contact center agent was scheduled, an on queue percentage of the respective assignable contact center agent, and a resulting quality of service of the contact center if the respective assignable contact center agent is assigned.

In some embodiments, to add the assignable contact center agents to the pre-existing scheduled sessions may further include to assign the assignable contact center agents according to the sorted descending order.

In some embodiments, to select the session from the plurality of candidate sessions to open may include to determine a respective percentage of contact center agents that can attend each session of the plurality of candidate sessions.

In some embodiments, to select the session from the plurality of candidate sessions to open may include to determine overstaffing with respect to minimum staffing requirements for each of a plurality of planning groups of the contact center that the unassigned contact center agents can handle.

In some embodiments, the plurality of instructions may further cause the computing system to re-assign at least one contact center agent assigned to another session in response to a determination that a number of contact center agents assigned to the opened session is not at least a minimum group size for the opened session.

In some embodiments, to assign the unassigned contact center agents to the opened session may include to sort the unassigned contact center agents in descending order by a respective average number of sessions since a last time the respective unassigned contact center agent was scheduled.

In some embodiments, to assign the unassigned contact center agents to the opened session may include to sort the unassigned contact center agents in descending order by an on queue percentage of the respective unassigned contact center agent.

In some embodiments, to assign the unassigned contact center agents to the opened session may include to sort the unassigned contact center agents in descending order by a resulting quality of service of the contact center if the respective unassigned contact center agent is assigned.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIG. 3 is a simplified flow diagram of at least one embodiment of a method for multi-objective schedule optimization in contact centers;

FIG. 4 is a simplified flow diagram of at least one embodiment of a method for adding initial activity rules to a queue;

FIG. 5 is a simplified flow diagram of at least one embodiment of a method for generating candidate slots for an activity rule;

FIG. 6 is a simplified flow diagram of at least one embodiment of a method for scheduling an activity rule using a mixed integer programming (MIP) model;

FIG. 7 is a simplified flow diagram of at least one embodiment of a method for pre-processing data for scheduling an activity rule;

FIG. 8 is a simplified flow diagram of at least one embodiment of a method for scheduling an activity rule using a heuristic-based approach;

FIG. 9 illustrates example abbreviations, notations, and/or sets to be used in conjunction with the MIP model of FIG. 6;

FIG. 10 illustrates example abbreviations, notations, and/or sets to be used in conjunction with the heuristic-based approach of FIG. 8; and

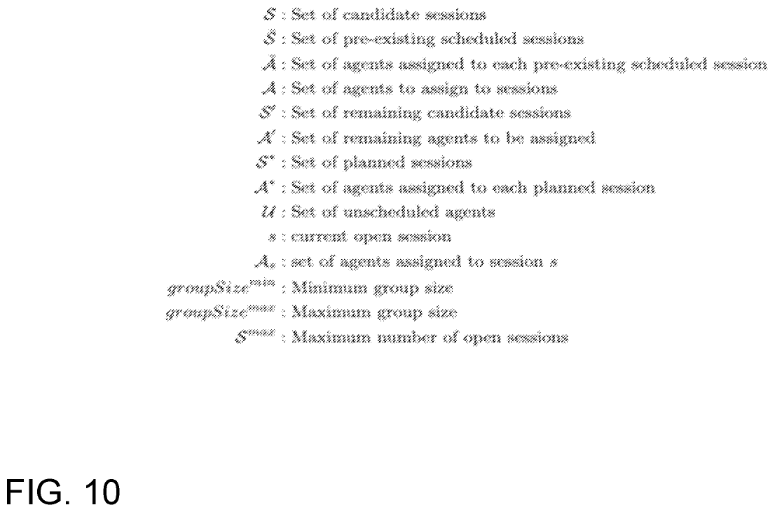

FIG. 11 is a simplified example of pseudocode for at least one embodiment of the heuristic-based approach of FIG. 8.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

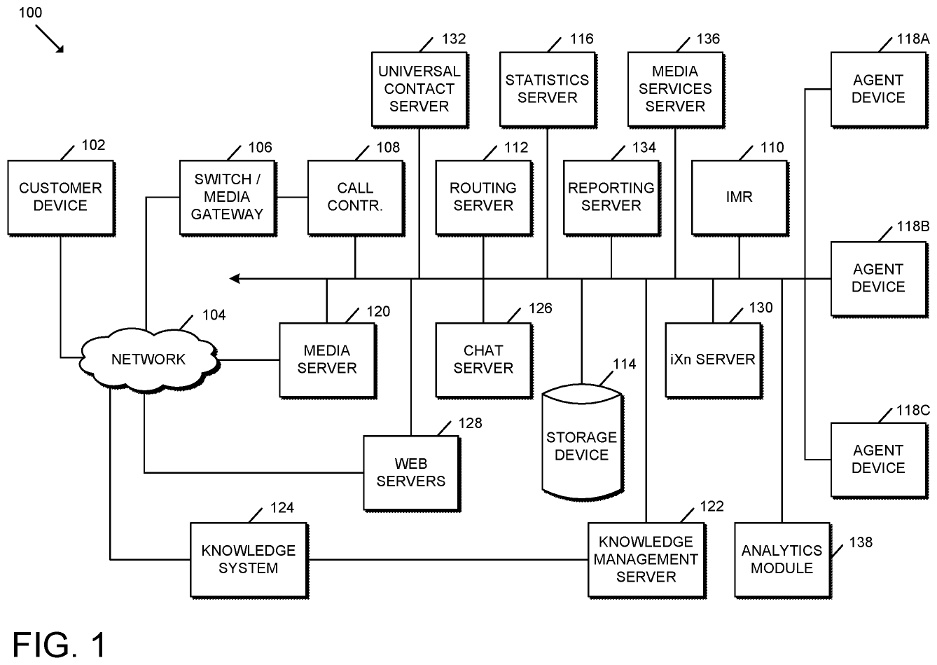

Referring now to FIG. 1, a simplified block diagram of at least one embodiment of a communications infrastructure and/or content center system, which may be used in conjunction with one or more of the embodiments described herein, is shown. The contact center system 100 may be embodied as any system capable of providing contact center services (e.g., call center services, chat center services, SMS center services, etc.) to an end user and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

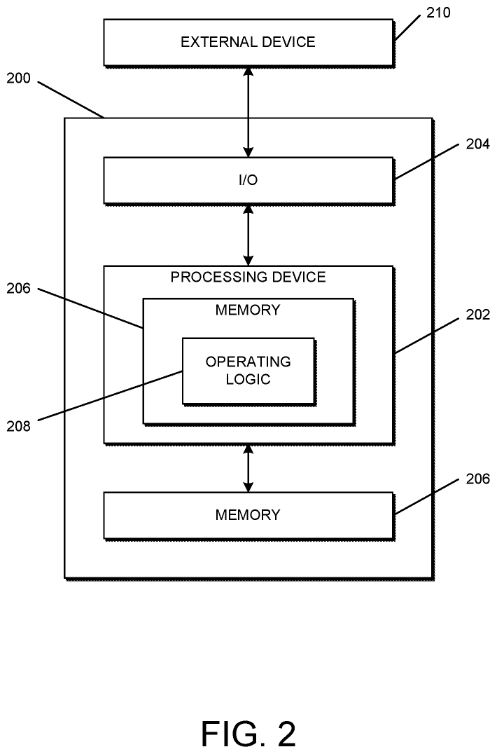

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VOIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VOIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VOIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

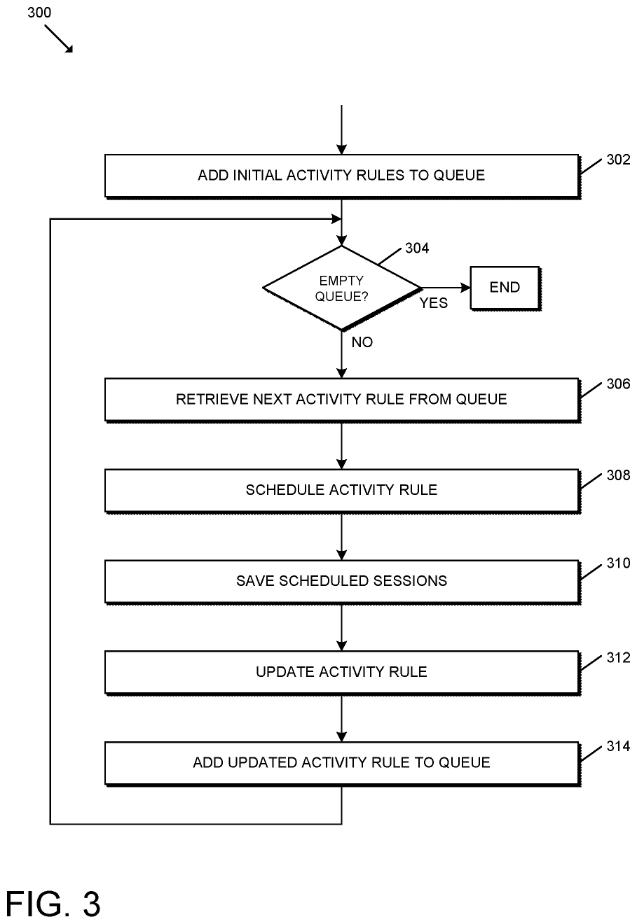

FIGS. 3-8 illustrate various methods associated with multi-objective schedule optimization in contact centers. As described above, contact centers address the challenging task of scheduling the right number of employees with the right skills at the right time to meet the expected interaction workload while also satisfying quality of service metrics. It should be appreciated that scheduling activities may involve finding the number of sessions to schedule and the time and attendees for each session while minimizing or limiting the impact on quality of service. Scheduling activities such as training, one-on-one sessions, and all-hands sessions in contact centers is a complex and time-consuming task, especially in contact centers that support multiple types of interactions and whose agents have different skillsets (e.g., the agents can handle different types of interactions, handle interactions in different languages, etc.), and have different schedules.

It should be appreciated that the activities scheduled by the computing system may include any action that would require an agent's attention or presence (physical or virtual) such that the agent would not be available to handle contact center interactions. Accordingly, the scheduling of activities may have a negative impact on the quality of service of the contact center, particularly when scheduling large, common meetings with many attendees (e.g., all-hands meetings). The technologies described herein minimize and/or limit the negative impact of the scheduling of activities on the quality of service of the contact center by analyzing various factors such as, for example, agent/facilitator availability, agent skillsets, interaction workloads, physical constraints (e.g., room size), and/or other relevant considerations.

The scheduling of activities is also a computationally “hard” problem. As the problem size increases (e.g., with more potential agent attendees, more potential times to schedule the meeting, and/or other variables), some optimization approaches may not be viable due to increased run time and memory requirements. In other words, solving the scheduling problem may be so computationally complex that traditional computer-based, mathematically-driven approaches are unable to solve the problem in a short enough time to be a viable practical solution. It should be appreciated that the technologies described herein may even utilize multiple approaches (e.g., an MIP-based model and a heuristic approach) to address the potential computational complexity of the scheduling problem. For example, in some embodiments, the computing system may utilize the MIP-based model approach unless one or more thresholds associated with the scheduling complexity are surpassed (e.g., number of potential agent attendees, number of potential schedule slots, etc.), in which case the computing system may “fall back” to or otherwise utilize the heuristic approach described herein. In some embodiments, the MIP-based approached may be solved using a cloud-based constraint programming solver.

In the illustrative embodiment, the computing system solves the problem of scheduling the maximum number of potential attendees to an activity while minimizing (or limiting) the impact on quality of service of the contact center. In some embodiments, an activity can be scheduled in different/multiple activity sessions and, therefore, a feasible solution to the problem is a set of activity sessions, such that each activity session is defined as a start time, a list of attendees, and a facilitator. In other embodiments, it should be appreciated that a particular activity session may self-guided without a facilitator.

Meeting sessions are scheduled when the attendees (i.e., the contact center agents and the facilitator) are available. It should be appreciated that the attendee availability may be provided or described in the form of one or more published schedules, in time segments, and/or in another suitable format. In the illustrative embodiment, when availability is given in a published schedule, the activities are scheduled during working hours. Various portions of the working time may fall into one or more time categories/classifications depending on the particular embodiment. For example, in the illustrative embodiment, the agent's working time may be categorized as on-queue time (in which the agent is available to handle interactions) or as a shift activity such as breaks and meals. It should be further appreciated that various shift activities may defined as interruptible or non-interruptible (e.g., times corresponding with agent time-off requests), such that agents can only be assigned to a meeting session when on-queue or on an interruptible activity.

If an agent is scheduled to participate in a particular activity, as described above, the scheduled activity reduces the agent's availability to handle contact center interactions. Accordingly, in the illustrative embodiment, the computing system uses the schedules and skillsets of all contact center agents (or the relevant subset of agents) that contribute to handling interactions (not merely those who would be scheduled in meeting sessions) when calculating the impact that scheduling a meeting/session would have on the quality of service of the contact center over the scheduling period. In a typical multi-skilled contact center, various agents have different skill sets. Some agents may only handle a few types of interactions, whereas other agents (e.g., more experienced agents) may handle many types of interactions. Thus, the impact on quality of service when assigning an agent to a meeting/session not only depends on the agent's skill set and interaction workload, but also on the other agents' (e.g., unscheduled agents') ability to handle certain types of interactions. It should be further appreciated that, as described herein, the scheduling of activities may also be done in view of various defined constraints (e.g., number of attendees per session, number of sessions, session recurrence, etc.).

It should be appreciated that the activities planned/scheduling may include meetings (e.g., one-on-one, one-to-many, many-to-many, or all-hands) and/or learning/coaching sessions for individual agents and/or groups of agents. As described above, the computing system finds planned activities and applies them to one or more schedules. Each planned activity may consist of one or more planned activity sessions, and each session can be facilitated (i.e., have a facilitator present) or un-facilitated/self-guided (i.e., not have a facilitator present). It should be appreciated that a facilitated session is only able to be planned if both the attendees and a facilitator are available (e.g., during on-que time or during interruptible activities), and an un-facilitated session is only able to be planned if the attendees are available (e.g., during on-que time or during interruptible activities).

In some embodiments, agent attendees may be selected from one or more predefined lists of potential attendees. Further, depending on the particular circumstances, the facilitators may be agent-facilitators (e.g., contact center agents who are also able to facilitate a particular session), supervising facilitators (e.g., agent supervisors who are able to facilitate a particular session), and/or external facilitators (e.g., facilitators from outside the contact center). It should be appreciated that the agent-facilitators and supervising facilitators may belong to the business unit, whereas the external facilitators do not. Further, agent-facilitators may contribute to coverage in the contact center (e.g., as a member of the relevant planning group), but the supervising facilitators and external facilitators do not impact coverage (e.g., the ability of the contact center to handle interactions) in the contact center.

An activity rule may include all of the information needed to find a planned activity. For example, in some embodiments, the activity rule may include the start time at which a session can be scheduled, the session length, agents and their availability, facilitators and their availability, recurrence settings, group settings, and/or the optimization objective. The activity rule recurrence settings may include the count and data of the last occurrence of the rule (e.g., the last recurrence), the minimum time between occurrences, and when the recurrence ends. In some embodiments, the recurrence settings in the activity rule may indicate that several planned activities (with planned activity sessions) must be planned. For example, in some embodiments, the activity recurrence may be daily, weekly, or according to another period. Accordingly, in an embodiment that has a weekly recurrence setting that recurs four time (e.g., for four weeks), the computing system plans four activities with each activity representing one occurrence. Each of these occurrences may represent a list of sessions with start time, facilitator, and attendees. The group settings may include limits or constraints that apply to planned activities and sessions, such as the minimum number of attendees that can be scheduled in a session, the maximum number of attendees that can be scheduled in a session, the maximum number of sessions allowed per planned activity, the maximum number of concurrence sessions allowed per planned activity, and/or other group-related settings. The optimization objective may give the user a way to provide preferences in terms of the impact in service level allowed when planning activities. For example, in the illustrative embodiment, the two different optimization objectives are supported: “favor service level” and “favor all attendees.” Although both optimization objectives attempt to schedule as many attendees as possible (i.e., with the particular optimization objective in mind), the “favor service level” objective may allow sessions to be scheduled only to the extent that it does not hurt coverage beyond a minimum service level (e.g., by causing additional understaffing), whereas the “favor all attendees” objective may allow understaffing (e.g., up to a threshold percentage beyond the minimal service level) in an effort to schedule all attendees. It should be appreciated that the computing system may use different optimization objectives and/or a different number of optimization objectives depending on the particular embodiment. The schedule information may be used to know the agents' and facilitators' availability and to calculate the impact of an activity plan on the quality of service of the contact center. The schedule information may include the management unit settings, agent capabilities, agent on-queue times, and agent interruptible ranges.

Referring now specifically to FIG. 3, in use, a computing system (e.g., the contact center system 100, the computing device 200, and/or other computing devices described herein) may execute a method 300 for multi-objective schedule optimization in contact centers. It should be appreciated that the particular blocks of the method 300 are illustrated by way of example, and such blocks may be combined or divided, added or removed, and/or reordered in whole or in part depending on the particular embodiment, unless stated to the contrary.

In various embodiments, the method 300 may take as input a list of rules and return a list of planned activities, with each planned activity having a list of sessions, and one planned activity per rule processed. The rules may be added to a queue and processed sequentially, with the main steps being, for example, queueing the rule, scheduling the rule, and updating the rule. More specifically, the algorithm to process rules may start by queueing the initial activity rules and choosing a queued activity to be scheduled. In some embodiments, the order in which the queued activity rules are scheduled may be in descending order by maximum group size, then by descending order by maximum session count, and then by ascending order by candidate session count. The computing system schedules the rule to find the optimal (or best possible) sessions for that rule. The planned activity obtained by the scheduling is stored, and the rule is updated. It should be appreciated that, when the rule's recurrence settings require it, a rule may be updated and queued. As discussed above, a planned activity represents the sessions for one activity occurrence, and the recurrence settings for a particular planned activity may require several occurrences. When there are no rules remaining to be processed, the algorithm may terminate and all of the planned activities may be returned by the computing system.

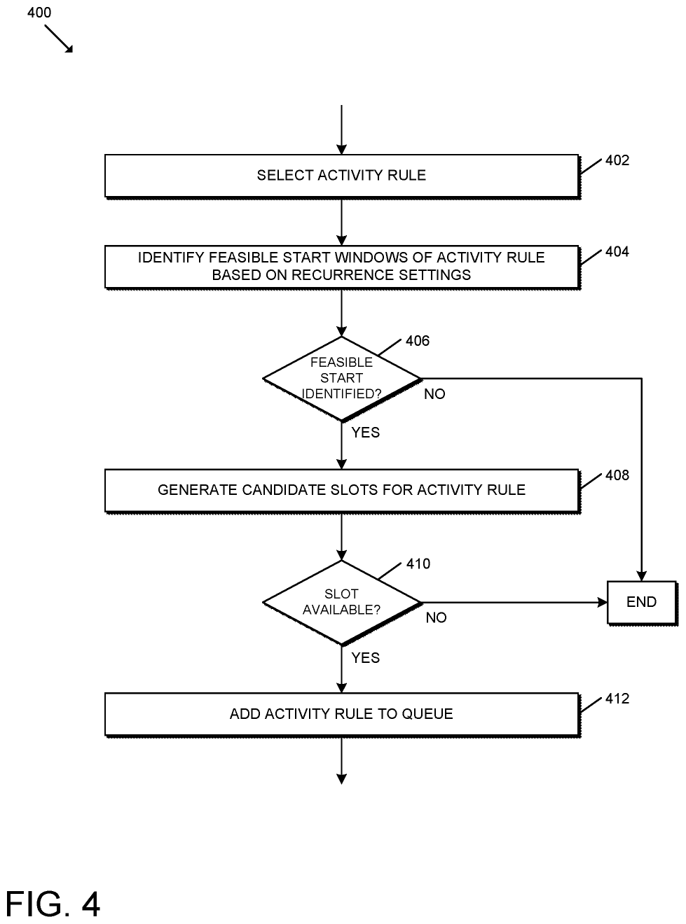

The illustrative method 300 begins with block 302 in which the computing system adds initial rules to the queue. To do so, in some embodiments, the computing system may execute the method 400 of FIG. 4 described below. For example, the computing system may find feasible start windows of each rule and add the rule to the queue if there is a candidate slot available for that rule.

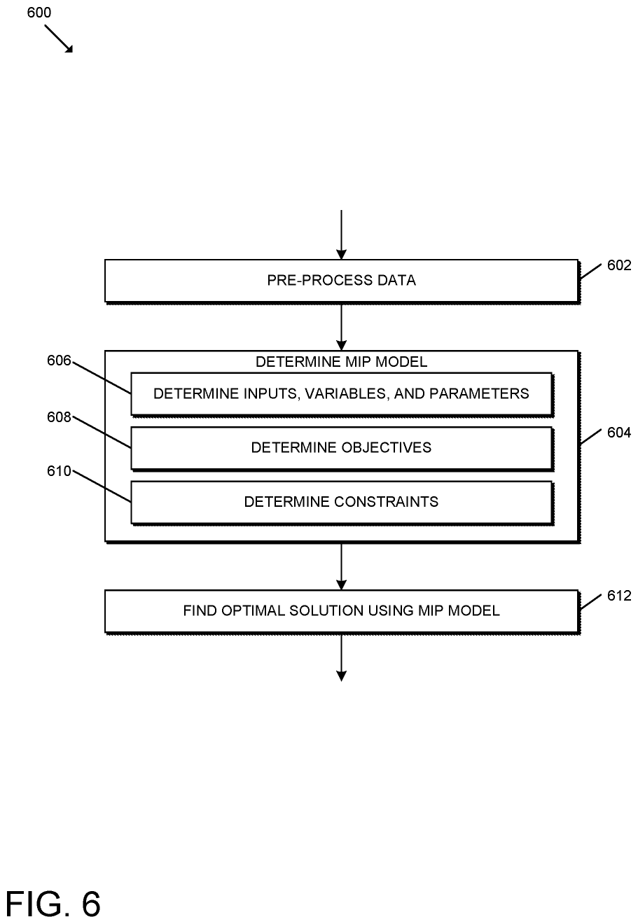

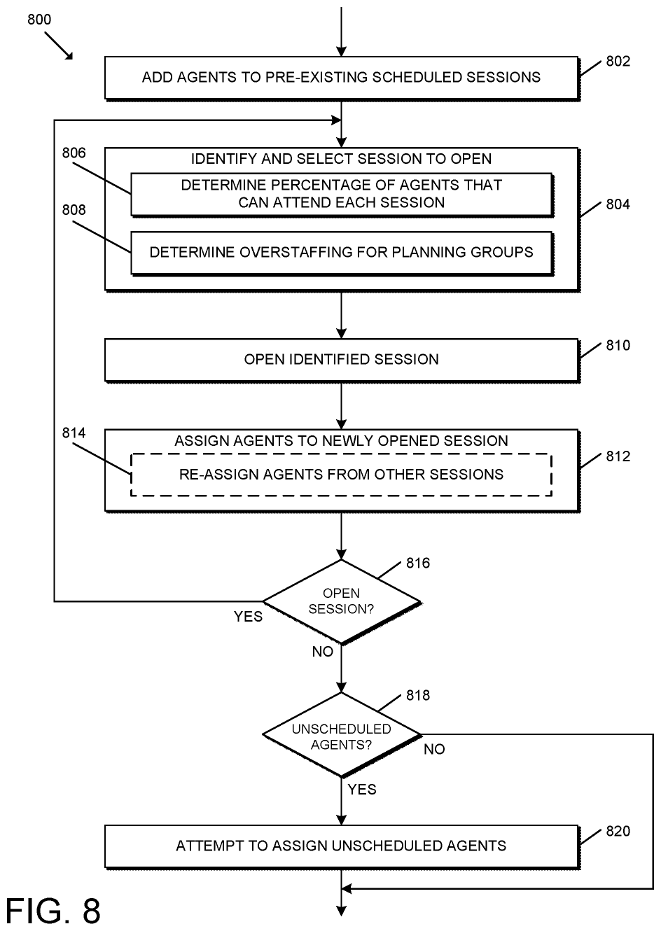

In block 304, the computing system determines whether the queue is empty, or whether there remain rules to be scheduled on the queue. If the queue is empty, the method 300 terminates. However, if there remain one or more rules to be scheduled on the queue, the method 300 advances to block 306 in which the computing system retrieves the next activity rule from the queue. In block 308, the computing system schedules the activity rule. As described herein, in scheduling the activity rule, the computing system may find the optimal sessions given the particular rule. For example, in some embodiments, after candidate slots are found for a rule, candidate sessions may be calculated, and an activity planning algorithm may be used to find the best assignment of agents to candidate sessions (e.g., to minimize the negative impact on contact center coverage). In the illustrative embodiment, the scheduling of one activity may result in a list of scheduled sessions. It should appreciated that the computing system may utilize any suitable scheduling algorithm and/or technologies consist with the features described herein. For example, in some embodiments, the computing system may execute the method 600 of FIG. 6 described below to schedule the activity rule using a mixed integer programming (MIP) model. In other embodiments, the computing system may execute the method 800 of FIG. 8 described below to schedule the activity rule using a heuristic-based approach. As described herein, in some embodiments, the computing system may evaluate one or more characteristics in order to determine which scheduling algorithm to execute. For example, in some embodiments, the computing system may select the MIP model algorithm unless the size of the problem is too large (e.g., the number of agents to assign, the number of candidate sessions, etc.) in which case the computing system may select the heuristic approach to scheduling the activity rule. In some embodiments, the threshold number of agents for selecting the MIP-based or heuristic-based approach to scheduling is 6,000 agent attendees. However, it should be appreciated that another threshold number may be used in other embodiments.

In block 310, the computing system saves the scheduled sessions to a data storage of the computing system. In block 312, the computing system updates the activity rule based on the scheduling of the activity rule. For example, in some embodiments, the activity rule may include recurrence settings that indicate that the rule should be executed periodically (e.g., daily, weekly, etc.) in which case the activity rule may be updated with a timestamp (or other indicia) of the most recent scheduling of the activity rule. In block 314, the updated activity rule may be added to the queue (or added back to the queue). In some embodiments, the activity rule may be later added back to the queue (e.g., after a time period has expired). The method 300 returns to block 304 in which the computing system determines whether the queue is empty.

Although the blocks 302-314 are described in a relatively serial manner, it should be appreciated that various blocks of the method 300 may be performed in parallel in some embodiments.

Referring now to FIG. 4, in use, a computing system (e.g., the contact center system 100, the computing device 200, and/or other computing devices described herein) may execute a method 400 for adding initial activity rules to a queue. It should be appreciated that the particular blocks of the method 400 are illustrated by way of example, and such blocks may be combined or divided, added or removed, and/or reordered in whole or in part depending on the particular embodiment, unless stated to the contrary.

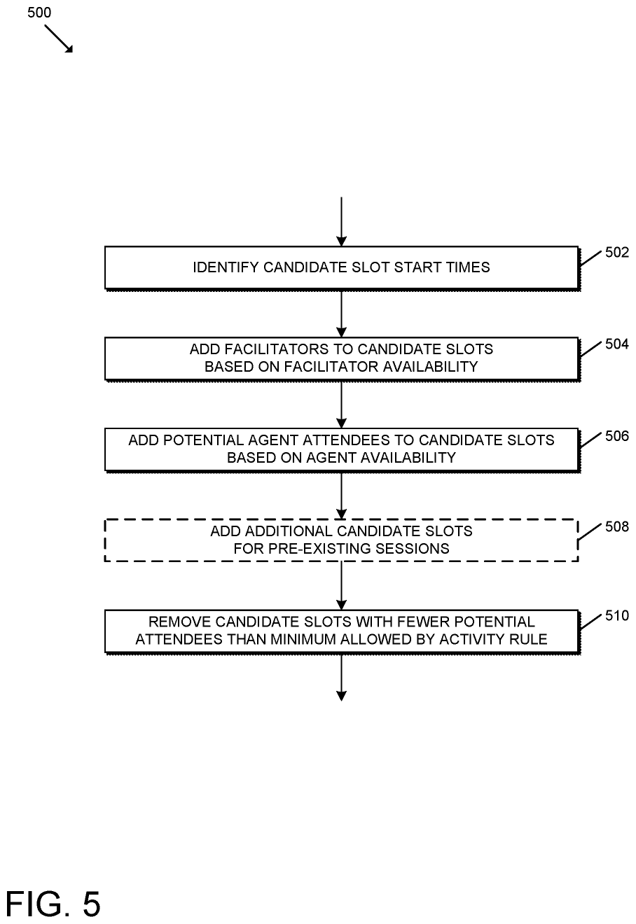

The illustrative method 400 begins with block 402 in which the computing system selects an activity rule (e.g., from a list of input rules). In block 404, the computing system identifies feasible start windows of the activity rule based on recurrence settings of the rule. If the computing system determines, in block 406, that at least one feasible start window of the activity rule has been identified, the method 400 advances to block 408 in which the computing system generates candidate slots for the activity rule. To do so, the computing system may execute the method 500 of FIG. 5 described below. In some embodiments, each of the candidate slots represents a start time and a list of potential facilitators that sessions can be scheduled for a particular activity rule, and candidate slots can be used to compute candidate sessions. For example, suppose an activity rule with a candidate slot that starts at Interval X has Facilitator A and Facilitator B. The candidate lot corresponds with two different candidate sessions; the two candidate sessions start at the same time (Interval X) but have different facilitators (Facilitator A for one candidate session and Facilitator B for the other candidate session). If the computing system determines, in block 410, that a candidate slot is available for the activity rule, the method 400 advances to block 412 in which the computing system adds the activity rule to the queue.

Although the blocks 402-412 are described in a relatively serial manner, it should be appreciated that various blocks of the method 400 may be performed in parallel in some embodiments.

Referring now to FIG. 5, in use, a computing system (e.g., the contact center system 100, the computing device 200, and/or other computing devices described herein) may execute a method 500 for generating candidate slots for an activity rule. It should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the computing system identifies one or more candidate slot start times (e.g., from the provided availability). In block 504, the computing system adds facilitators to the candidate slots based on the availability of each of the facilitators. For example, as described above, the same candidate slot may account for multiple candidate sessions (e.g., the same candidate slot time with a first candidate session having a first facilitator and a second candidate session having a second facilitator). In block 506, the computing system adds potential agent attendees to the candidate slots based on the availability of each of the agents. In some embodiments, in block 508, the computing system may add additional candidate slots for pre-existing sessions. In block 510, the computing system removes candidate slots with fewer potential attendees than a minimum number of attendees allowed by the activity rule (i.e., if the activity rule defines a minimum number of attendees).

Although the blocks 502-510 are described in a relatively serial manner, it should be appreciated that various blocks of the method 500 may be performed in parallel in some embodiments.

Referring now to FIG. 6, in use, a computing system (e.g., the contact center system 100, the computing device 200, and/or other computing devices described herein) may execute a method 600 for scheduling an activity rule using a mixed integer programming (MIP) model. It should be appreciated that the particular blocks of the method 600 are illustrated by way of example, and such blocks may be combined or divided, added or removed, and/or reordered in whole or in part depending on the particular embodiment, unless stated to the contrary.

In the illustrative embodiment, the MIP model optimally finds candidate sessions for one activity rule. Therefore, the model output is one planned activity. It should be appreciated that the MIP technique may find optimal solutions using a branch and cut technique, which enumerates branches of a tree and prunes them accordingly.

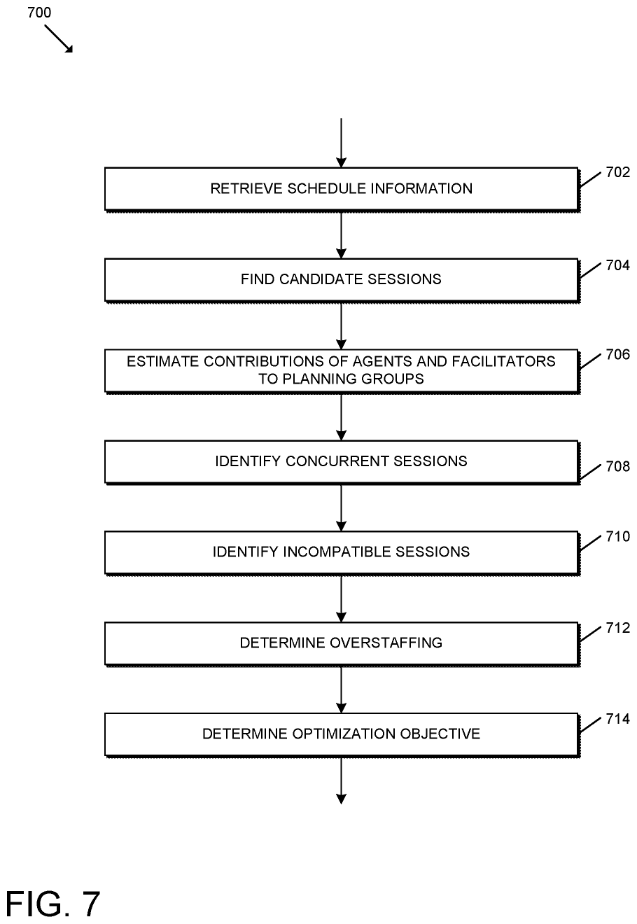

The illustrative method 600 begins with block 602 in which the computing system pre-processes various data for solving the MIP model. It should be appreciated that various data may be pre-processed and/or calculated depending on the particular embodiment. For example, in the illustrative embodiment, the computing system executes the method 700 of FIG. 7 to pre-process data. Referring now to FIG. 7, in use, a computing system (e.g., the contact center system 100, the computing device 200, and/or other computing devices described herein) may execute a method 700 for pre-processing data for scheduling an activity rule. It should be appreciated that the particular blocks of the method 700 are illustrated by way of example, and such blocks may be combined or divided, added or removed, and/or reordered in whole or in part depending on the particular embodiment, unless stated to the contrary.

The illustrative method 700 begins with block 702 in which the computing system retrieves schedule information for the contact center. As described above, the schedule information may include management unit settings, agent capabilities, agent on-queue times, agent interruptible ranges, and/or other relevant schedule information. In block 704, the computing system finds possible candidate session based on the schedule information. In the illustrative embodiment, each candidate session can only be facilitated by up to one facilitator, although some sessions (e.g., self-guided sessions) do not require a facilitator. In other embodiments, the system may be designed such that multiple facilitators may be assigned to a particular candidate session (e.g., up to a maximum number of facilitators per session). Each of the candidate sessions may be tagged or associated with a unique identifier, and indicators may be made for sessions that have been previously scheduled, such that the model (e.g., the MIP model) can distinguish the sessions and knows to schedule the previously scheduled sessions.

In block 706, the computing system estimates the contributions of the agents and facilitators to the planning groups. As described herein, such information helps with understanding the impact on quality of service of assigning an agent (and/or a facilitator) to a session to prevent understaffing when possible. For example, if a particular activity/session is scheduled in the morning, the negative impact to the staffing requirements may differ from scheduling the same activity/session in the afternoon. The planning group defines a set of skills that are necessary to resolve inquiries belonging to that particular planning group and, therefore, an agent belonging to a particular planning group is able to resolve inquiries categorized in that planning group. For example, a planning group may be associated with a set of skills, media types, languages, and/or other characteristics (e.g., one planning group may be associated with inbound sales call in the Spanish language). As such, it should be appreciated that a particular agent may be a member of or assigned to multiple planning groups depending on the agent's skillset.

In block 708, the computing system computes or otherwise identifies concurrent sessions based on the possible candidate sessions. In some embodiments, the computing system or model (e.g., the MIP model) may limit the number of concurrent sessions to a predefined maximum number. In block 710, the computing system computes or otherwise identifies incompatible sessions based on the possible candidate sessions. It should be appreciated that incompatible sessions are those sessions which are unable to both be scheduled, as they are mutually exclusive to one another. For example, a single facilitator is unable to facilitate one candidate session at a particular time slot while simultaneously facilitating another candidate session at the same time slot and, therefore, those candidate sessions are incompatible with one another. It should be further appreciated that additional and/or alternative criteria may exist for determining whether two candidate sessions are compatible or incompatible with one another. For example, in some embodiments, the computing system or model (e.g., the MIP model) may require that a certain rest period elapse after a particular facilitator (or agent) scheduled to a particular session may be assigned to a subsequent candidate session.

In block 712, the computing system computes or otherwise determines overstaffing with respect to the minimum staffing requirements needed for each planning group across the schedule window. It should be appreciated that such information helps with understanding how agents can be assigned to sessions without hurting the quality of service. As described herein, the system administrator may establish a minimum staffing requirement that performance should not fall below. For example, the minimum staffing requirement may be associated with a certain service level, such as that at least 80% of calls should be answered within 20 seconds, emails should be answered on average within 24 hours, or calls should be answered quickly enough that no more than 5% of the calls are abandoned (e.g., dropped before being answered by an agent).

In block 714, the computing system extracts from the activity rule or otherwise determines the optimization objective associated with the particular activity rule. For example, as described above, in the illustrative embodiment, each of the activity rules may define an activity rule as having a “favor all attendees” optimization objective or a “favor service level” optimization objective. Although both optimization objectives attempt to schedule as many attendees as possible (i.e., with the particular optimization objective in mind), the “favor service level” objective may allow sessions to be scheduled only to the extent that it does not hurt coverage beyond a minimum service level (e.g., by causing additional understaffing), whereas the “favor all attendees” objective may allow understaffing (e.g., up to a threshold percentage beyond the minimal service level) in an effort to schedule all attendees. It should be appreciated that the computing system may use different optimization objectives and/or a different number of optimization objectives depending on the particular embodiment.

Although the blocks 702-714 are described in a relatively serial manner, it should be appreciated that various blocks of the method 700 may be performed in parallel in some embodiments.

Referring back to FIG. 6, in block 604, the computing system determines or retrieves data associated with the MIP model. More specifically, in block 606, the computing system determines the relevant inputs, variables, and/or parameters for the MIP model. Further, in block 608, the computing system determines the objectives to be used for the MIP model. In block 610, the computing system determines the constraints to be used for the MIP model.

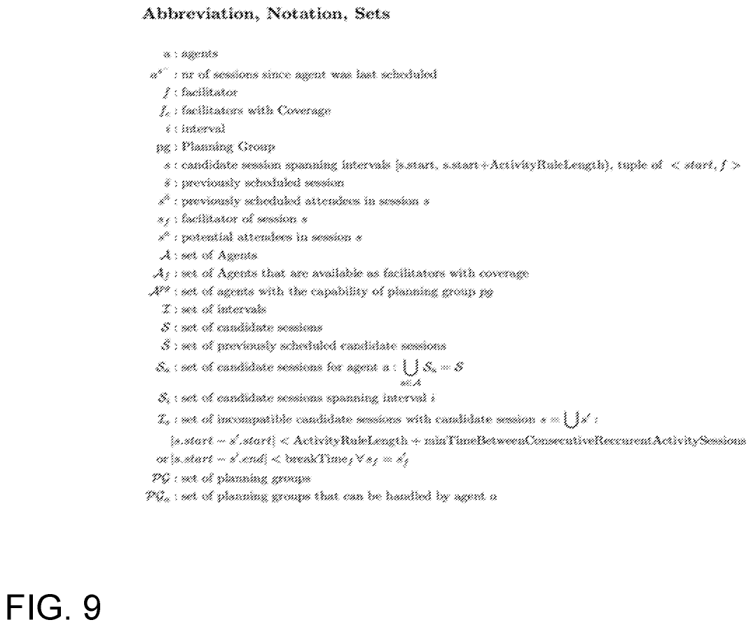

In the illustrative embodiment, it should be appreciated that the MIP model may utilize various notations, sets, and abbreviations. FIG. 9 illustrates an example of notations, sets, and abbreviations that may be used in conjunction with the MIP model described herein. As described herein, various decision variables, inputs, parameters, and expressions may be used. For example, in the illustrative embodiment, the decision variables include X_{a,s}∈B (which is a binary variable to denote whether agent, a, is assigned to session, s), Uₐ∈B (which is a binary variable to denote whether agent, a, is unassigned), Yₛ∈B (which is a binary variable to denote whether session, s, is used), slackᵢ^{pg}∈R⁺ (which is a continuous variable slack to denote how much service level was violated for planning group, pg, in session, s), and groupSizeₛ (which is the size of session, s). Additionally, in the illustrative embodiment, the inputs include ObjectiveMode∈[FavorSL, Favor AllAgents] (which indicates whether the optimization objective should “favor service level” or “favor all agents” as described above), Group Min E Z⁺ (which is the minimum group size), GroupMax∈Z⁺ (which is the maximum group size), S (which is the set of all candidate sessions), Sₐ (which is the set of all agent candidate sessions), μ_{[a,pg,i]} (which are assignments with shrinkage from agent, a, to planning group, pg, at interval, i), and Φᵢ^{pg} (which is FTE available over minimum service level, and can be obtained by translating the service level goals to minimum FTE). In the illustrative embodiment, the parameters include slackCostCoefficient (which is a coefficient for slack cost), unassignedCostCoefficient (which is a coefficient for unassigned cost), interruptedCostCoefficient (which is a coefficient for interrupted activity sessions costs), sessionsOpenedCostCoefficient (which is a coefficient for sessions opened),

$${occupancyFactor}_{[ a , pg ]} = \frac{occ}{100} \cdot {IsDeferred}_{pg} + ( 1 - {IsDeferred}_{pg} )$$

(which is an occupancy factor), and onQ_{a,s} (which is the on queue percentage of agent, s, and session, s).

As described above, various expressions may be used. For example, the expressions may include:

$${groupSize}_{s} = \vert {s}^{\overline{a}} \vert + \vert {s}^{a} \vert , \\ UnassignedCost = unassignedCostCoefficient \cdot {\sum }_{a ϵ A} {U}_{a} \cdot ( 1 + {a}^{{s}^{-}} ) , \\ slackCost = \{ \begin{matrix}slackCostCoefficient {\sum }_{pg , i} {slack}_{i}^{pg} & if ObjectiveMode = FavorAllAgents \\ 0 & otherwise\end{matrix} , \\ {slack}_{i}^{pg} \leq \{ \begin{matrix}∞ & if ObjectiveMode = FavorAllAgents \\ 0 & otherwise\end{matrix} , \\ {U}_{a} \leq \{ \begin{matrix}0 & if ObjectiveMode = FavorAllAgents \\ 1 & otherwise\end{matrix} , \\ InterruptedActCost = interruptedCostCoefficients \cdot {\sum }_{a ϵ A , s ∈ {S}_{a}} {X}_{a , s} \cdot ( 1 - {onQ}_{a , s} ) , and \\ sessionsOpenedCost = sessionOpenedCostCoefficient \cdot {\sum }_{s ϵ S} {Y}_{s}$$

In the illustrative embodiment, it should be appreciated that there are three primary decisions made in the MIP model: which agents are unassigned, which candidate sessions are scheduled, and which agents are assigned to each of the scheduled sessions. The MIP model generates, determines, or otherwise utilizes a set of variables for each of these decisions, which may be defined as binary decisions (e.g., assigned/unassigned, scheduled/unscheduled, etc.). Additionally, as described herein, the MIP model relies on another set of constraints to calculate understaffing, and these continuous variables may be used in the objective function.

In the illustrative embodiment, the objective of the MIP model is to minimize the weighted sum of four different objectives (minimizing unassigned agents, minimizing understaffing caused by scheduling a session, minimizing interrupted activity sessions, and minimizing the opened session percentage). More specifically, the computing system may minimize the unassigned agents, for example, to encourage fairness between agents when scheduling their assignments to sessions (e.g., using the UnassignedCost expression described above), minimize understaffing caused by scheduling a session by minimizing the deviation between the planned service level due to the introduced activity sessions and the minimum service level (e.g., using the slackCost expression described above), minimize interrupted activity sessions to minimize interruptions due to an agent's activity session overlapping with an interruptible activity and ensure smoother execution of activity sessions (e.g., using the InterruptedActCost expression described above), and minimize the opened session percentage to minimize the percentage of sessions that are successfully scheduled and assigned to agents and encourage maximizing the utilization of available sessions (e.g., using the sessionsOpenedCost expression described above). It should be further appreciated that the overall objective may be combined as a single objective function. For example, in the illustrative embodiment, the objective function may be defined as:

$$objective\_function = \{ \begin{matrix}min ( sessionsOpenedCost + slackCost + & if ObjectiveMode = \\ InterruptedActCost ) & FavorAllAgents \\ min ( UnassignedCost + sessionsOpenedCost + & otherwise \\ InterruptedActCost ) & \end{matrix}$$

As described above, the optimization may occur in view of various constraints. In the illustrative embodiment, the constraints include that the agents are either assigned or unassigned to one session, the number of agents in a scheduled session is at least the minimum group size, the number of agents in a scheduled session is at most the maximum group size, previously scheduled sessions are scheduled (i.e., cannot be unscheduled by the algorithm), agent-facilitators must be scheduled if the session is scheduled, the scheduled session count must be at most the maximum total session count, the number of concurrent sessions is at most the maximum allowable number of concurrent sessions, only one session in any of the sets of incompatible sessions can be chosen, and the understaffing due to scheduled sessions is calculated. The constraint that the agents are either assigned or unassigned to one session may be determined according to Σ_{s∈S}_{ₐ}X_{a,s}+Uₐ−1=0∀s∈A\A_{f}. The constraint that the number of agents in a scheduled session is at least the minimum group size may be determined according to groupSizeₛ−GroupMin·Yₛ≥0∀s∈S\S̅. The constraint that the number of agents in a scheduled session is at most the maximum group size may be determined according to groupSizeₛ−max(|s^{ā}|, GroupMax)·Yₛ≤0∀s∈S. In the illustrative embodiment, any previously scheduled that have already violated the maximum group size may be allowed but cannot be assigned additional attendees. The constraint that previously scheduled sessions are scheduled (i.e., cannot be unscheduled by the algorithm) may be determined according to Y_{s̅}=1∀s̅∈S̅. The constraint that agent-facilitators must be scheduled if the session is scheduled ensures that if a session requires an agent-facilitator (e.g., a facilitator that is in the same business unit and is capable of handling work/interactions), the facilitator must be assigned to the session. The constraint may be determined according to X_{a,s}=Yₛ∀S∈S: s_{f}∈A_{f}. The constraint that the scheduled session count must be at most the maximum total session count limits the total number of sessions that can be scheduled. The constraint may be determined according to Σ_{s∈S\S̅}Yₛ≤(TotalSessions−|S̅|)·(TotalSessions>|S̅|). In some embodiments, if the previously scheduled sessions (e.g., manually scheduled sessions) have exceeded this limit, the MIP model may respect this decision and ensure that the total number of sessions does not further exceed the specified limit. The constraint that the number of concurrent sessions is at most the maximum allowable number of concurrent sessions restricts the number of concurrent sessions to less than or equal to the maximum allowable concurrent sessions. The constraint may be determined according to Σ_{s,s′∈S\S̅}_{ₜ}_{:s overlaps s′}Yₛ≤(MaxConcurrentSessions−[S̅ₜ]). (MaxConcurrentSessions>|S̅ᵢ|)∀i∈I. In some embodiments, for previously scheduled sessions, the MIP model can allow this to be violated since they were previously scheduled and ensures no further violation of the specified maximum. The constraint that only one session in any of the sets of incompatible sessions can be chosen enforces the mutual exclusivity of choosing two incompatible sessions. It ensures that if two sessions are marked as incompatible with each other, only one of the sessions can be selected for scheduling. The constraint may be determined according to Yₛ+Y_{s′}−1≤0∀s∈S,s′∈Iₛ. The constraint that the understaffing due to scheduled sessions is calculated calculates the impact on quality of service caused by an activity plan. When the optimization is set to “favor service level,” no understaffing is permitted. However, when the optimization objective is set to “favor all attendees,” understaffing below the minimum staffing requirements is allowed, calculated by this set of constraints, and minimized by the objective function. The constraint may be determined according to Σ_{a∈A}_{^{pg}}_{,s∈S}_{ᵢ}_{∩S}_{ₐ}occupancyFactor_{[a,pg]}·μ_{[a,pg,i]}·X_{a,s}≤Φᵢ^{pg}+slackᵢ^{pg}∀pg∈PG,i∈I.

In block 612, the computing system finds an optimal solution to scheduling using the MIP model. For example, the computing system may execute the MIP algorithm based on the MIP model determined according to the various inputs, variables, parameters, expressions, objectives, and constraints.

Although the blocks 602-612 are described in a relatively serial manner, it should be appreciated that various blocks of the method 600 may be performed in parallel in some embodiments.

Referring now to FIG. 8, in use, a computing system (e.g., the contact center system 100, the computing device 200, and/or other computing devices described herein) may execute a method 800 for scheduling an activity rule using a heuristic-based approach. It should be appreciated that the particular blocks of the method 800 are illustrated by way of example, and such blocks may be combined or divided, added or removed, and/or reordered in whole or in part depending on the particular embodiment, unless stated to the contrary.

In some embodiments, the heuristic-based approach may be a variant of the next-fit algorithm. The heuristic algorithm may begin by assigning additional agents to pre-existing scheduled sessions. Then, the heuristic opens a session one at a time and tries to assign agents to that session. When no longer possible to assign additional agents, the heuristic opens another session. The activity planning may have constraints to be considered when opening sessions and/or assigning agents to sessions. To meet these constraints, the remaining agents to assign and remaining session to open may be periodically updated (i.e., agents and candidate sessions may be removed from being eligible to assign/choose to open). The heuristic continues opening sessions and assigning agents to them until no session to open is found or the maximum number of planned sessions is reached.

The illustrative method 800 begins with block 802 in which the computing system adds agents to pre-existing scheduled sessions. It should be appreciated that pre-existing scheduled sessions may be provided as input to the heuristic and, in the illustrative embodiment, pre-existing scheduled sessions cannot be eliminated or changed. However, additional agents can be assigned to those pre-existing scheduled sessions. In particular, in the illustrative embodiment, for each pre-existing scheduled sessions, assignable agents (e.g., potential agent attendees who have not been assigned to any session) are sorted in descending order by their average number of sessions since last time scheduled, on queue percentage, and resulting quality of service if assigned. For each agent in the ordered list, the computing system may determine whether the assignment is feasible, which may depend on the optimization objective. For example, as described above, if the optimization objective is “favor all attendees” an assignment will be feasible; however, if the optimization objective is “favor service level,” an assignment is deemed infeasible if it causes understaffing.

In block 804, the computing system identifies and selects a session to open (e.g., from a plurality of candidate sessions, which may be identified in a manner similar to that described herein). In doing so, in block 806, the computing system may determine a percentage of agents that can attend each session and, in block 808, the computing system may determine overstaffing for the planning groups. In the illustrative embodiment, the heuristic keeps only one session open at a time. The open session is scheduled, and a new session is opened if there are no more agents to be assigned to the session or the session has reached a maximum group size. To choose a session to open, the computing system calculates two terms for each candidate session: a sum of the on queue percentage of agents that can attend the session and the session's remaining overstaffing for only the planning groups that the remaining agents can handle. If the sum of the on queue percentage of agents that can attend the session is a high value, that indicates that the session does not overlap with the agent's interruptible activities, so it should be open. Similarly, if the session's remaining overstaffing for only the planning groups that the remaining agents can handle is a high value, that indicates that the agents can be assigned to the session without hurting coverage for the contact center. It should be appreciated that, in some embodiments, the computing system may, additionally or alternatively, evaluate one or more constraints described above in reference to the MIP model to determine whether the session can be opened. Further, in some embodiments, the computing system may rely on pre-processed data similar to that described above in reference to the MIP model.

It should be further appreciated that choosing a session to open can be computationally expensive, especially for exceptionally large cases in which there are many candidate sessions. Thus, in some embodiments, the heuristic may include two sub-routines for choosing a session to open depending on the number of candidate sessions. If the number of candidate sessions is less than some predefined threshold, the heuristic may sort all candidate sessions every time it needs to choose a session to open. However, when there are more candidate sessions than the predefined threshold, the heuristic may sort the candidate sessions only once, and sessions may be opened in that order. Further, the heuristic may evaluate whether a session can be opened by checking that the maximum concurrent sessions and the minimum transition time between transitions is respected. In block 810, the computing system opens the session identified and selected to be opened.

In block 812, the computing system assigns agents to the newly opened session. For example, the agents may be assigned to the opened session until an allowable negative impact to coverage is met (or until a maximum session size is met). It should be appreciated that the computing system may assign agents to the newly opened session according to the same prioritization described above in reference to assignment to pre-existing sessions (e.g., sorted in descending order by their average number of sessions since last time scheduled, on queue percentage, and resulting quality of service if assigned). Further, in some embodiments, the number of agents assigned to the session must be greater than a predefined minimum group size. Accordingly, if the number of agents is fewer than the minimum group size, in block 814, the computing system may re-assign agents from other previously scheduled sessions to the newly opened session so that the minimum group size is satisfied. If a session is unable to reach the minimum group size, the agents assigned to the session may be moved to a list of remaining agents to be assigned. The computing system updates the remaining agents and the candidate sessions.

Throughout the heuristic, some agents might not be able to be assigned and some candidate sessions might not be able to be opened anymore. For example, agents may not be assigned if there are not candidate sessions that they can attend. Candidate sessions may not be opened because the maximum concurrent sessions in the intervals that overlap the candidate session has been reached, or the minimum time between sessions is not respected. Thus, each time a session is planned and another session needs to be open, the computing system removes the agents that cannot be assigned and the candidate session that cannot be chosen so that they are not evaluated anymore in the heuristic.

In block 816, the computing system determines whether to open another session (e.g., after the session is full). If so, the method 800 returns to block 804 to identify and select another session to open. If not, the method 800 advances to block 818 in which the computing system determines whether there are unscheduled agents. If so, the method 800 advances to block 820 in which the computing system attempts to assign the unscheduled agents to a session (e.g., without opening a new session). For example, the computing system attempts to assign additional agents to the already open sessions without exceeding any limits on a maximum number of agents in the respective session.

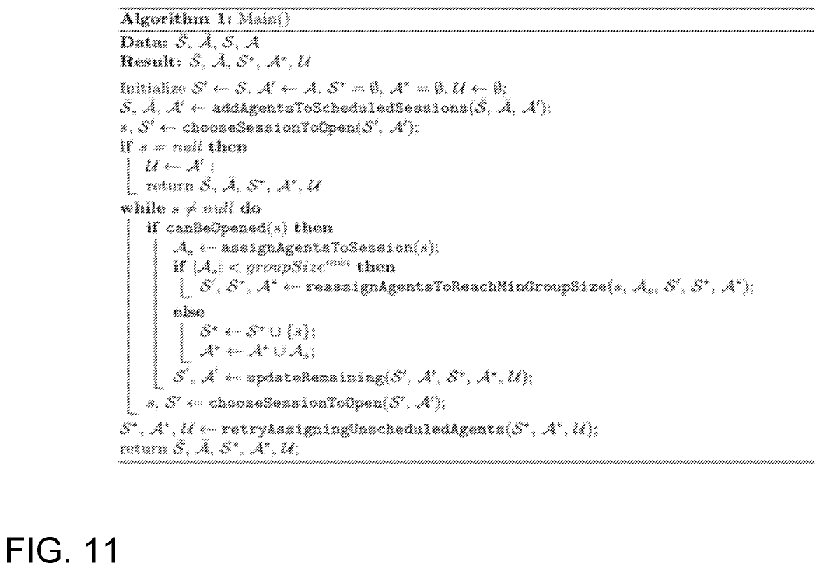

Although the blocks 802-820 are described in a relatively serial manner, it should be appreciated that various blocks of the method 800 may be performed in parallel in some embodiments. FIG. 11 is a simplified example of pseudocode for at least one embodiment of the heuristic-based approach of FIG. 8.

What is claimed is:

1. A method of leveraging a heuristic-based approach to multi-objective schedule optimization in contact centers, the method comprising:
adding, by a computing system, assignable contact center agents to pre-existing scheduled sessions;
selecting, by the computing system, a session from a plurality of candidate sessions to open in response to adding the assignable contact center agents to the pre-existing scheduled sessions;
opening, by the computing system, the selected session; and
assigning, by the computing system, unassigned contact center agents to the opened session, wherein at most one session of the plurality of candidate sessions is open for assignment at a given time.

2. The method of claim 1, wherein adding the assignable contact center agents to pre-existing scheduled sessions comprises sorting the assignable contact center agents in descending order by at least one of a respective average number of sessions since a last time the respective assignable contact center agent was scheduled, an on queue percentage of the respective assignable contact center agent, and a resulting quality of service of the contact center if the respective assignable contact center agent is assigned.

3. The method of claim 2, wherein adding the assignable contact center agents to the pre-existing scheduled sessions further comprises assigning the assignable contact center agents according to the sorted descending order.

4. The method of claim 1, wherein selecting the session from the plurality of candidate sessions to open comprises determining a respective percentage of contact center agents that can attend each session of the plurality of candidate sessions.

5. The method of claim 1, wherein selecting the session from the plurality of candidate sessions to open comprises determining overstaffing with respect to minimum staffing requirements for each of a plurality of planning groups of the contact center that the unassigned contact center agents can handle.

6. The method of claim 1, further comprising re-assigning, by the computing system, at least one contact center agent assigned to another session in response to determining that a number of contact center agents assigned to the opened session is not at least a minimum group size for the opened session.

7. The method of claim 1, wherein assigning the unassigned contact center agents to the opened session comprises sorting the unassigned contact center agents in descending order by a respective average number of sessions since a last time the respective unassigned contact center agent was scheduled.

8. The method of claim 1, wherein assigning the unassigned contact center agents to the opened session comprises sorting the unassigned contact center agents in descending order by an on queue percentage of the respective unassigned contact center agent.

9. The method of claim 1, wherein assigning the unassigned contact center agents to the opened session comprises sorting the unassigned contact center agents in descending order by a resulting quality of service of the contact center if the respective unassigned contact center agent is assigned.

10. The method of claim 1, wherein assigning the unassigned contact center agents to the opened session comprises assigning the unassigned contact center agents to the opened session until an allowable negative impact to coverage of the contact center is met.

11. The method of claim 1, wherein assigning the unassigned contact center agents to the opened session comprises assigning the unassigned contact center agents to the opened session until a maximum session size is met.

12. A computing system for leveraging a heuristic-based approach to multi-objective schedule optimization in contact centers, the system comprising:
at least one processor; and
at least one memory comprising a plurality of instructions stored thereon that, in response to execution by the at least one processor, causes the computing system to:
add assignable contact center agents to pre-existing scheduled sessions;
select a session from a plurality of candidate sessions to open in response to adding the assignable contact center agents to the pre-existing scheduled sessions;
open the selected session; and
assign unassigned contact center agents to the opened session, wherein at most one session of the plurality of candidate sessions is open for assignment at a given time.

13. The computing system of claim 12, wherein to add the assignable contact center agents to pre-existing scheduled sessions comprises to sort the assignable contact center agents in descending order by at least one of a respective average number of sessions since a last time the respective assignable contact center agent was scheduled, an on queue percentage of the respective assignable contact center agent, and a resulting quality of service of the contact center if the respective assignable contact center agent is assigned.

14. The computing system of claim 13, wherein to add the assignable contact center agents to the pre-existing scheduled sessions further comprises to assign the assignable contact center agents according to the sorted descending order.

15. The computing system of claim 12, wherein to select the session from the plurality of candidate sessions to open comprises to determine a respective percentage of contact center agents that can attend each session of the plurality of candidate sessions.

16. The computing system of claim 12, wherein to select the session from the plurality of candidate sessions to open comprises to determine overstaffing with respect to minimum staffing requirements for each of a plurality of planning groups of the contact center that the unassigned contact center agents can handle.

17. The computing system of claim 12, wherein the plurality of instructions further causes the computing system to re-assign at least one contact center agent assigned to another session in response to a determination that a number of contact center agents assigned to the opened session is not at least a minimum group size for the opened session.

18. The computing system of claim 12, wherein to assign the unassigned contact center agents to the opened session comprises to sort the unassigned contact center agents in descending order by a respective average number of sessions since a last time the respective unassigned contact center agent was scheduled.

19. The computing system of claim 12, wherein to assign the unassigned contact center agents to the opened session comprises to sort the unassigned contact center agents in descending order by an on queue percentage of the respective unassigned contact center agent.

20. The computing system of claim 12, wherein to assign the unassigned contact center agents to the opened session comprises to sort the unassigned contact center agents in descending order by a resulting quality of service of the contact center if the respective unassigned contact center agent is assigned.
